(19) United States
(12) Patent Application Publication
(10) Pub. No.: US 2012/0278243 A1
(43) Pub. Date: Nov. 1, 2012

(54) Determination of Appraisal Accuracy

(75) Inventors: Ronald Lynn Frazier, Villa Park, CA (US); Daniel Brian Sogorka, Encinitas, CA (US); Mark Richard Johnson, Newport Beach, CA (US); Jeffrey Albert Sanderson, Coto De Caza, CA (US); John David Holbrook, Suwanee, GA (US)

(73) Assignee: LPS IP Holding Company LLC, Jacksonville, FL (US)

(21) Appl. No.: 13/458,893

(22) Filed: Apr. 27, 2012

Related U.S. Application Data
(60) Provisional application No. 61/480,909, filed on Apr. 29, 2011.

(51) Int. Cl. G06Q 30/00

(52) U.S. Cl. 705/306

(57) ABSTRACT

A method for determining the accuracy of an appraisal report using a computer implemented application, including pre-validating an appraisal report to determine whether a first set of rules has been satisfied, the appraisal report including N fields to be completed, the first set of rules comprising completion of a pre-determined number of N fields; proceeding to a post-validating step if the first set of rules is satisfied; post-validating an appraisal report to provide an evaluation thereof, the evaluation including a plurality of risk categories including risk level indicators, and a risk-based overall score.

### PRIORITY

This application claims the benefit of U.S. Patent Application No. 61/480,909, filed Apr. 29, 2011 and titled, “Determination of Appraisal Accuracy,” which is hereby incorporated by reference in its entirety into this application.

### BACKGROUND OF THE INVENTION

The mortgage-related downturn in the U.S. economy, occurring in the late 2000's, has resulted in a renewed emphasis on accuracy and quality of appraisals to better support responsible lending practices. As lenders and investors seek full faith and confidence before originating mortgage loans, and to effectively manage risk, a pristine appraisal has become an essential component to the origination process. Recently, the government sponsored entities (GSEs) set forth the Uniform Mortgage Data Program (UMDP), calling for sound underwriting practices aimed at improving appraisal quality and reducing risks. Traditionally, manual appraisal reviews have been the primary approach to appraisal quality control; however, manual reviews leave basic elements open to interpretation. As a result, inconsistencies in the appraisal report that may lead to the discovery of a problem might go unnoticed.

While there have been mortgage-related systems described for evaluation of loan risk and calculation of risk during the preparation of loans and systems that apply rules to obtain scores (see, e.g., US 2006/0224499, US 2008/0103963, U.S. Pat. No. 7,212,995, and U.S. Pat. No. 7,599,882, each of which is incorporated in its entirety into this application), there has not been described a comprehensive system for providing a determination of appraisal accuracy. Further, although a rules-based system called GAAR™ (Generally Accepted Appraisal Rules™) is currently available, which is asserted as providing a series of rules by which residential real estate appraisals are screened for completeness, compliance with rules and guidelines set forth by various regulatory bodies, and for signs of fraud, overvaluation and other elements representing risk to a lender, the output thereof consists of only a score, and there is no pre-validation process available. Moreover, the available system does not support individual lender customization.

Accordingly, it would be desirable to provide a system and tool that identify risks in appraisal reports in a streamlined secure manner. Moreover, it would be desirable to provide a two-stage product that includes first, a pre-validation step which focuses on factual errors, and a post-validation step that focuses on judgment errors. Further, it would be desirable to provide a two-stage product that requires passage of the first pre-validation step prior to progressing to the second post-validation step. Further still, it would be desirable to provide categories of validation based on industry standard rules, external data, and customizable lender thresholds, and a scoring protocol to efficiently assist lenders and investors. These and other aspects of a system to determine appraisal accuracy are described herein and appended hereto.

### SUMMARY

Various aspects and embodiments for a system and method for determining appraisal accuracy is described herein. The system to determine appraisal accuracy, in one embodiment, is a scoring tool that identifies risks in real estate appraisal reports. The system reduces time and errors for appraisal reviewers and underwriters by uncovering and flagging complex issues embedded within the appraisal report without any manual processing. The system uses appraisal data, configurable customer thresholds, mortgage and appraisal industry standards and external data sources to validate the appraisal for formatting and completeness. Risk flags and scores are reported in a clear and simple format.

Appraisal reviews can be time consuming for mortgage underwriters and appraisal reviewers. Inconsistencies may be missed because the basic elements within appraisal reports are subject to interpretation and could be misread as typical or within the range of guidelines. The system helps to automate, standardize and simplify the appraisal review process by gathering and processing available data and using configurable rules to process qualified results.

In one embodiment, a lender orders an appraisal from a dedicated service provider through a collaborative partner network (CPN). The CPN operates an electronic collaboration network of information utilized in the inventive appraisal accuracy system. The appraisal service provider completes the appraisal order and sends it back through the CPN for processing by the appraisal accuracy system, which sending automatically triggers a pre-validation report. Generally, the appraiser will use his software of choice to enter the appraisal data, which data is pushed to the CPN. If the appraisal does not pass the pre-validation step, thereby producing a failing report, the appraisal is sent back to the appraisal service provider, along with the pre-validation report, for revision in the areas identified by the report. After the appraisal passes the pre-validation step (either initially or after one or more revisions), a validation report is generated that, together with the pre-qualified appraisal, is forwarded to the lender.

In one embodiment, the validation report accesses various third-party data sources to evaluate appraisal data across several risk categories. The validation report identifies the subject property's complexity, comparable data and opinion of value by using public records such as mortgage, assessment and deed data. Data sources include, but are not limited to: The Appraisal Subcommittee (for appraisal credentials), public records (for mortgage assessment and deed data), and flood insurance providers. Risk Categories include, but are not limited to: subject property complexity, appraisal credentials, comparable data and opinion of values, and industry guidelines (e.g., Fannie Mae, Freddie Mac, FHA, USPAP, etc.).

In one embodiment, appraisal quality assessment is based upon the volume of issues found within the validation report and the information is delivered using easy to understand risk-based scoring levels. The validation report clearly identifies any appraisal data points that don't meet industry standards, and flags risk level indicators associated with a lender's customized pre-identified thresholds using the color convention Red, Yellow, Green, and Blue. In one embodiment, the color Green indicates a low risk of appraisal rejection, the color Yellow indicates a moderate risk of appraisal rejection (a cursory review of the appraisal is therefore recommended), the color Red indicates a high risk of appraisal rejection (an in-depth review of the appraisal is therefore recommended), and the color Blue indicates that outside data providers were unable to complete data verification (appraisal review recommended).

With respect to the industry standards, in one embodiment, automatic updates would be entered upon revisions going into effect so that any evaluation based on any revised guidelines would be current. Regarding lender customization, parameter values could be selected based on the desires of a particular lender. In one embodiment, the lender could select comparable real estate values to be taken from a five mile radius, while another lender could select a larger radius (e.g., ten miles). The lender customization could be manually entered by a system operator or be directly entered by the lender via web interface. In one embodiment, up to sixty fields are customizable by a lender or other client.

In one embodiment, a set of core rules are applied to the data to confirm key data points using the third-party data sources, and a four factor analysis is performed. First, certain data points are compared to data points in the third-party sources for an audit check of veracity, i.e., whether a stated property sold on a stated date for a stated amount. Second, the appraisals credentials are verified against an appropriate state licensing database to confirm the status of the appraiser as actively licensed and that other qualifications such as experience level specified by the lender are satisfied. Third, the property market characteristics are analyzed to determine the property's complexity, i.e., if the value of the property exceeds a certain threshold or if it is in a floodplain, it may be assigned a higher complexity value. Fourth, the assigned appraisal value is compared to an automated valuation model, which has been calculated by an external database to test whether the assigned value is within an expected tolerance of the automated predicted value. Following this analysis, in one embodiment, the inventive system uses an algorithm to dynamically weigh the complexity of the property and each of the results of the four factor analysis to assign a score and risk factor to the appraisal. In this embodiment, the weighting of the factors can be adjustable. For example, a property with complex characteristics may have a higher tolerance level between appraised value and an automated value such that a higher difference between the values is considered less important relative to the overall score.

With respect to the validation report output, in one embodiment, the report contains a risk assessment level, a score regarding the analysis of the appraisal data and a list of inconsistencies. An overall score and assessment is provided along with a more detailed report for each category of analysis and noted inconsistencies. In one embodiment, an electronic version is transmitted to the lender, which enables clicking of hyperlinks from a summary page to various areas of the report, depending on the areas of interest particular to the lender (where more detail is desired for review).

Lenders may use numeric risk scores within the report to define the appropriate level of appraisal review based on the level of risk identified. Numeric scores are determined from the volume of issues found within the collateral reports and are subsequently categorized into low, moderate or high risk levels.

The report provides numerous advantages to lenders. It saves time and reduces errors for underwriters and appraisal reviewers by identifying areas of potential risks that could be missed manually. It limits buybacks with investors by validating appraisal data against specific investor requirements. Lenders can configure the appraisal workflows with the report and use the latest industry guidelines and standards. It is flexible in supporting the appraisal ordering, correction and completion process. It provides an audit trail and integrates with existing lender and provider systems.

Providers also benefit from the report. The report enables collaboration with lender resources to correct any errors that may be found and reduces potential errors by finding incomplete, missing or erroneous information within the appraisal report. Providers can now react to errors and formatting issues in real time to make changes that previously may have taken days to uncover. This helps providers improve their ability to meet service level agreements with their lender clients.

Today's market environment places increasing importance on data quality and standardization. The report addresses this by providing high value to lenders and appraisers. The report's data-centric design enables validation and assessment of specific data elements across several key evaluation points, including an initial review of each data element within the valuation report for completeness and compliance with industry standards and best practices.

More specifically, based on the published GSE requirements associated with the Uniform Mortgage Data Program (UMDP), the report's data validation capabilities provide lenders with a centralized utility for ensuring valuation products' compliance with required industry data formats now and as they continue to evolve. This capability, combined with the existing company valuation product workflow and valuation provider integrations/relationships, provides a practical means of assisting providers with identifying situations requiring changes within their systems or processes to deliver data in the required standard format.

### BRIEF DESCRIPTION OF THE DRAWINGS

These and other objects, advantages and features of the present invention will be readily appreciated as the same becomes better understood by reference to the following detailed description when considered in connection with the accompanying drawings, in which like reference numerals designate like parts throughout the figures thereof and wherein:

FIG. 1 is a flowchart of a method in one embodiment of the present invention;

FIG. 2 is a flowchart of core rules used in an embodiment of the present invention;

FIG. 3A is an example of a low appraisal risk report cover page in accordance with an embodiment of the present invention;

FIG. 3B is an example of a report header in accordance with an embodiment of the present invention;

FIG. 3C is an example of an overall report score in accordance with an embodiment of the present invention;

FIG. 3D is an example of a subject property complexity in accordance with an embodiment of the present invention;

FIG. 3E is an example of an appraiser's credentials in accordance with an embodiment of the present invention;

FIG. 3F is an example of comparables in accordance with an embodiment of the present invention;

FIG. 3G is an example of threshold rules in accordance with an embodiment of the present invention;

FIG. 4 is an example of a pre-validation failure report in accordance with an embodiment of the present invention;

FIG. 5A is an example of a red high appraisal risk report cover page in accordance with an embodiment of the present invention;

FIG. 5B is an example of a rules violation report in accordance with an embodiment of the present invention;

FIG. 6A is an example of a blue high appraisal risk report cover page in accordance with an embodiment of the present invention; and

FIG. 6B is an example of a rules violation report in accordance with an embodiment of the present invention.

### DETAILED DESCRIPTION OF THE INVENTION

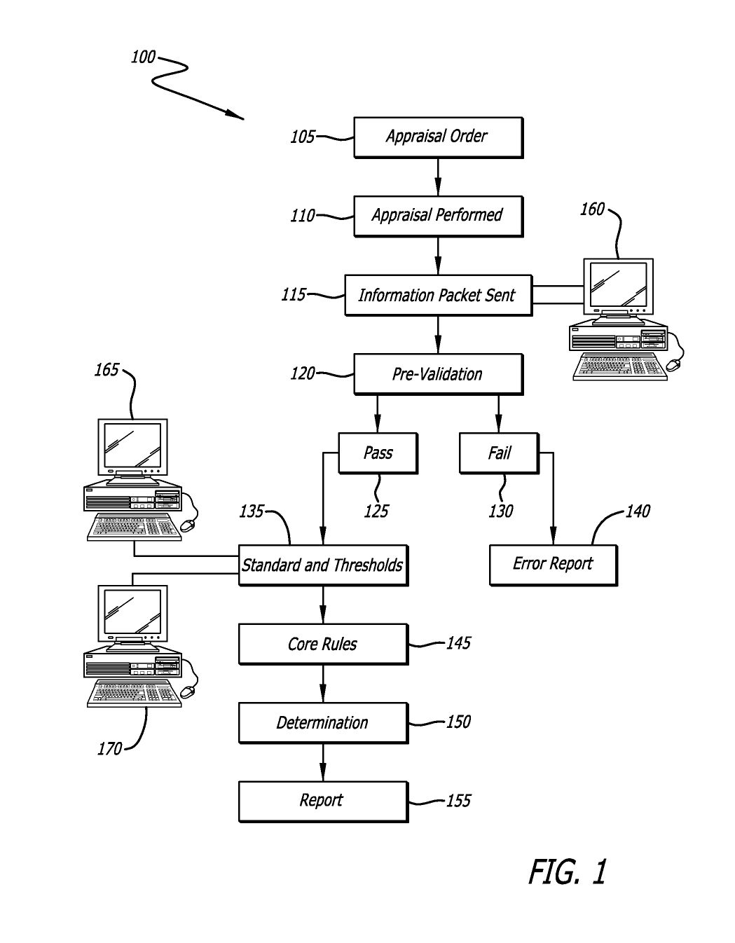

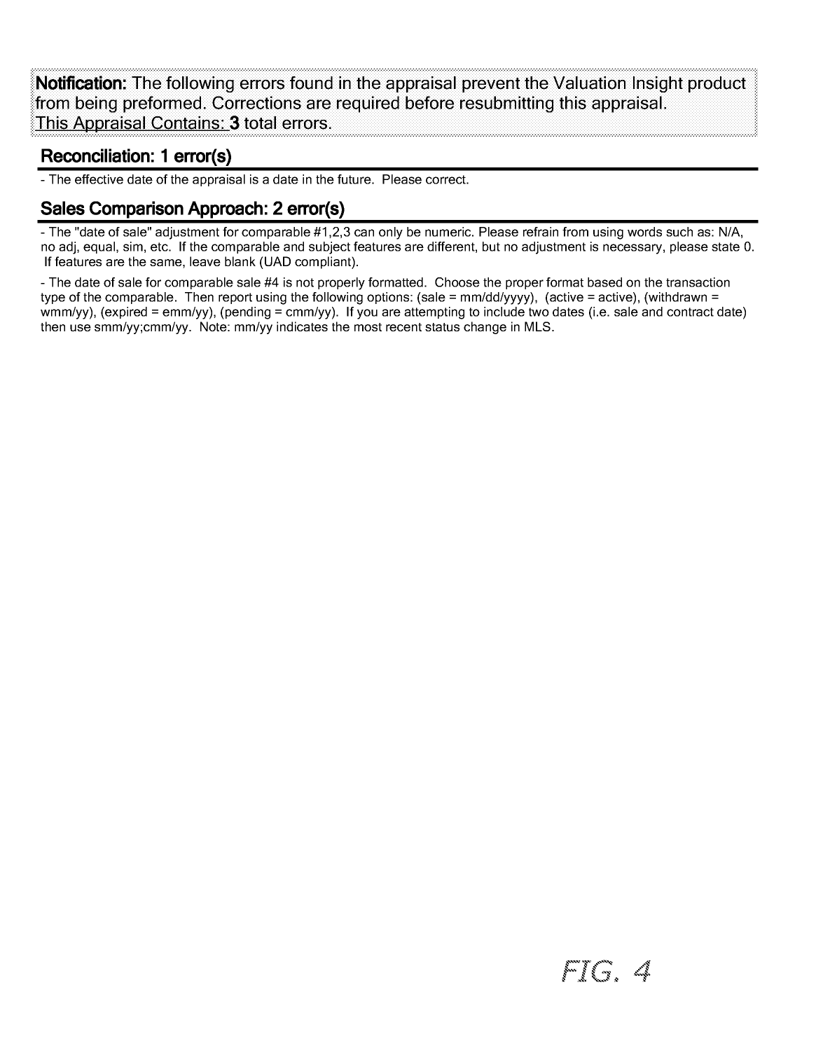

In FIG. 1, method for determining the accuracy of an appraisal report 100 using a computer-implemented application is shown. In the first step 105 of the method, a proposed lender generates an appraisal request to an appraiser or an appraisal management company, which then proceeds to conduct an appraisal 110. Once the appraisal is complete, the appraisal information is transmitted to a processing computer 160 as a packet of information 115. Pre-validation rules 120 are then applied to the packet of information to confirm that the data submitted is complete and normalized, meaning that all required fields have been completed, that the type of data is format compatible and that the data entered is within basic expected parameters. The pre-validation rules 120 validate the appraisal to verify the appraisal was completed and all data needed to complete the full report is present in the appraisal. The pre-validation rules 120 check and notate incomplete, missing, and inconsistent data within the appraisal report. If a violation 130 of the pre-validation rules is found, a pre-validation failure report 140 is generated, which highlights corrections required to the appraisal before the appraisal can be resubmitted for processing. FIG. 4 is an example of a pre-validation failure report. Errors, along with procedures to correct errors, are laid out for an appraiser's attention.

Once the pre-validation rules are satisfied, in the next step 135 the system compares the appraisal data to industry standard validation rules 165 and lender customized thresholds 170. Industry standard validation rules 165 are guidelines on how real estate appraisals should be conducted, for example as published by Fannie Mae or Federal Housing Administration (FHA) regulations. These may be manually written rules saved to the computer system, or a database of rules pulled from the relevant sources, allowing automatic updates when such guidelines are updated. Lender customized thresholds 170 are parameter values which may be selected by individual lenders to test data in an appraisal. For example, one lender may want comparable real estate values taken from within a five mile radius while another lender may select a ten mile radius. The lender customized thresholds 170 may be input into the system by the system operator, or through a lender interface to be accessed over a remote connection to select, change and save such thresholds. The results of the industry standard validation rules 165 and the customized threshold 170 applications are preferably a list of inconsistencies needing further review. Rule narratives within the report will highlight which specific guidelines have not been met. The rules also include standard rules designed to confirm key data points on the appraisal using external data sources. Discrepancies are highlighted and given a score of low, medium or high based upon client-defined thresholds.

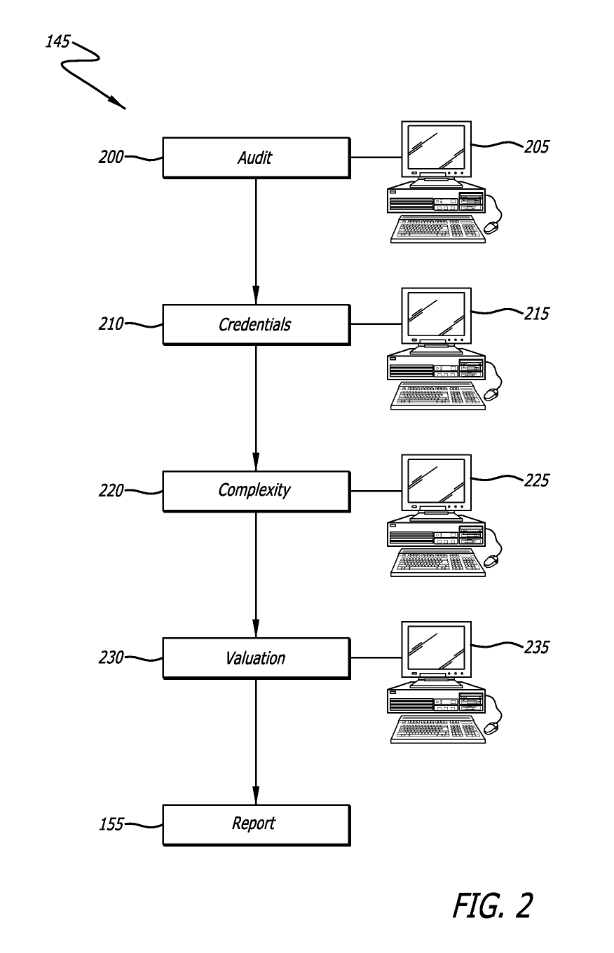

At the next step, a set of core rules 145 are applied to the data to confirm key data points using external data sources. This involves a four factor analysis, detailed in FIG. 2. First, certain data points 200 are compared to data points in external databases 205 purely for an audit check of the truthfulness of the information, for example was a particular property sold on a certain date for a certain amount. Second, the appraiser's credentials 210 are checked against an appropriate state licensing database 215 to confirm the status of the appraiser as actively licensed and that other qualifications such as the experience level specified by the lender are satisfied. Third, the core rules 145 compare the property market characteristics to an external database 225 to determine the complexity 220 of the property. For example, if the value of the property exceeds a certain threshold or if it is in a flood plane it may be deemed as more complex. Fourth, the core rules 145 compare the assigned appraisal value 230 to an automated valuation model, which has been calculated by an external database 235 to test whether the assigned value is within an expected tolerance of the automated predicted value.

Once the four factored analysis of the core rules 145 has been applied, the system uses a determination 150, for example via an algorithm, to dynamically weigh the complexity of the property and the core test results to assign a score and risk factor to the appraisal. Importantly, the weighting given to the different factors can change depending on the results of other factors. For example, a property with complex characteristics may have a higher tolerance level between appraised value and an automated value so a higher difference between the values is considered less important relative to the overall score in that situation.

Upon completion of the analysis, a report 155 is delivered to the lender containing a risk assessment level, a score regarding the analysis of the appraisal data and a list of inconsistencies. Preferably an overall score and assessment is provided as well as a more detailed report with respect to each category of analysis and the noted inconsistencies. The report provides an understanding of the complexity of the appraisal along with an overall score to allow for the correct level of review to occur. If major issues are identified, they are highlighted in a clear and concise manner to enable appropriate follow up actions. In a preferred version, an electronic version may be presented to the lender, allowing the lender to begin with a summary of the report, then click-through or drill down into more detailed information on subjects of interest.

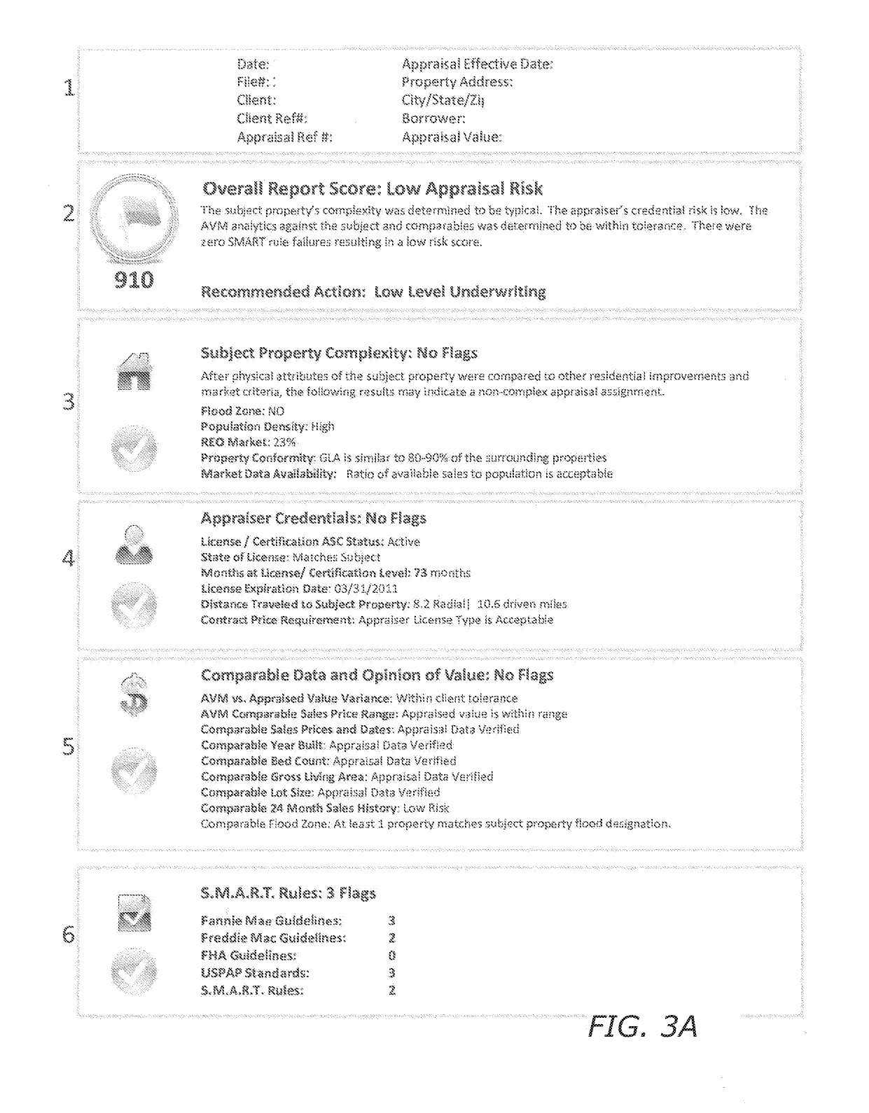

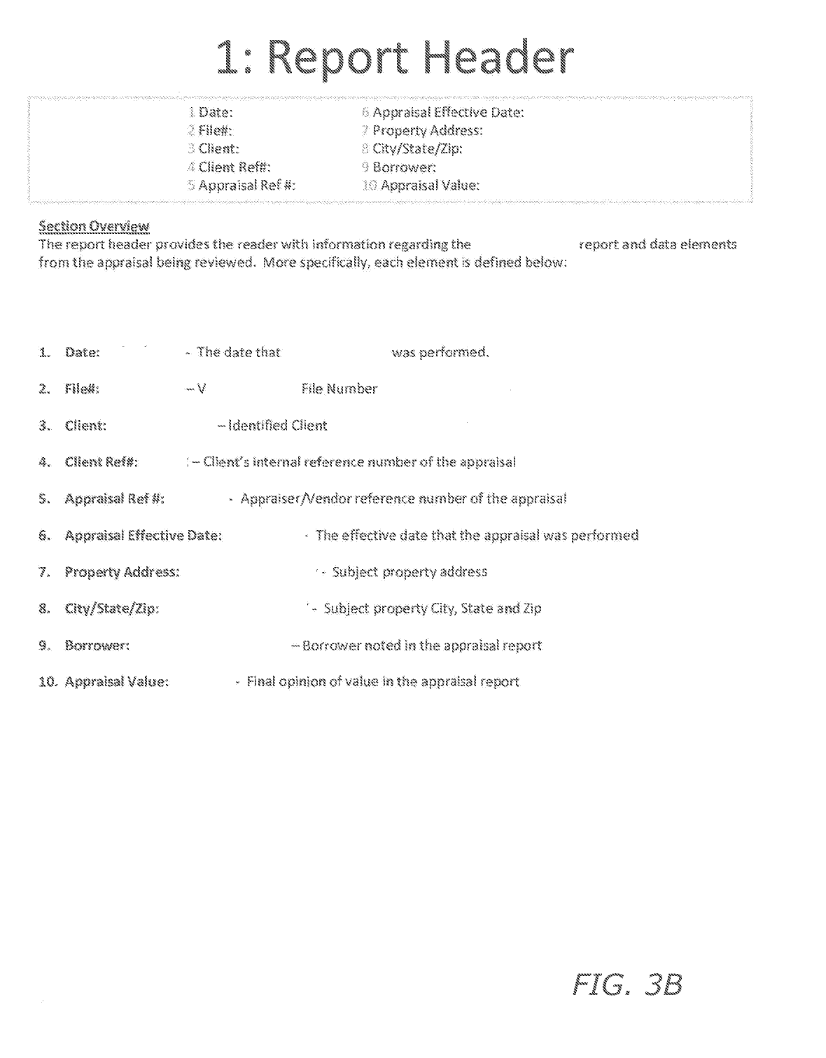

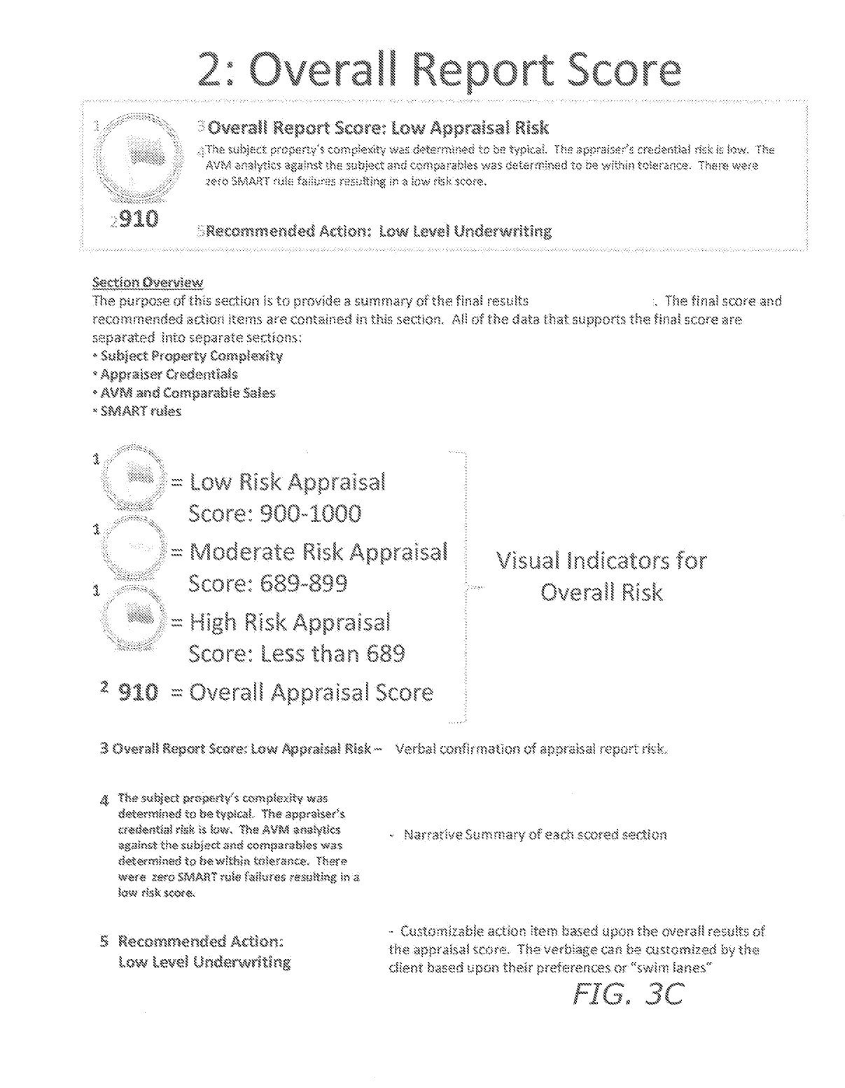

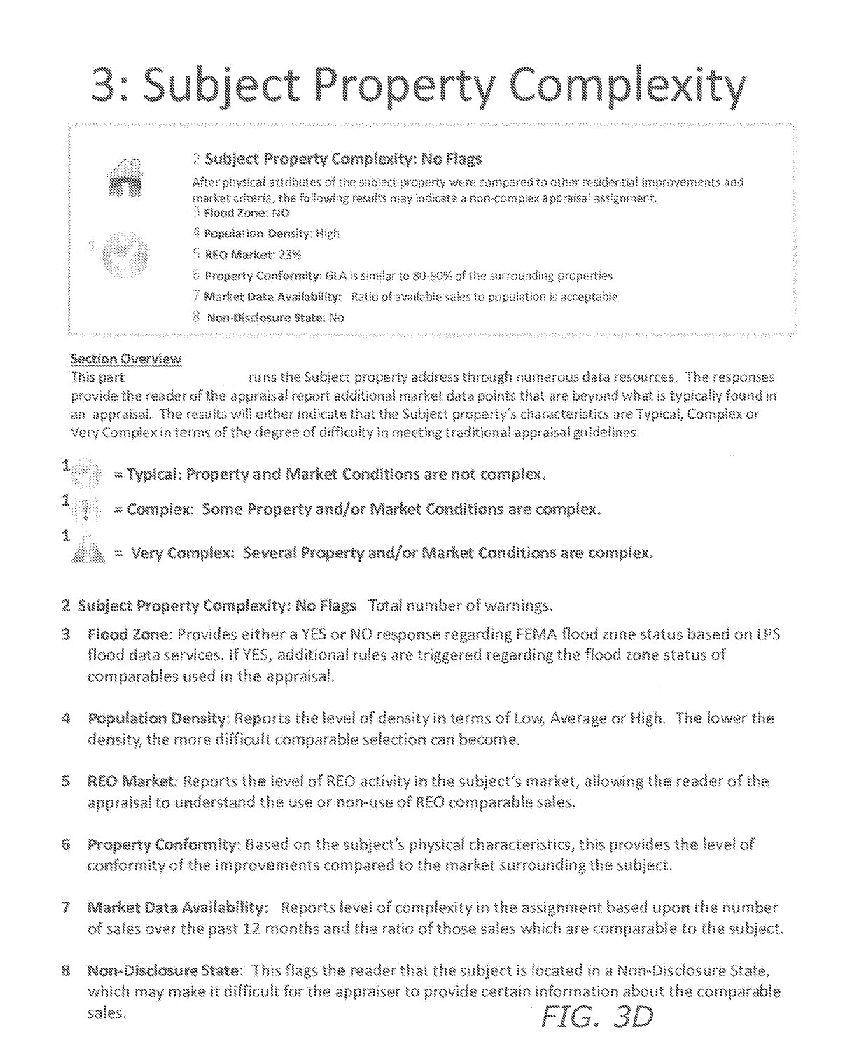

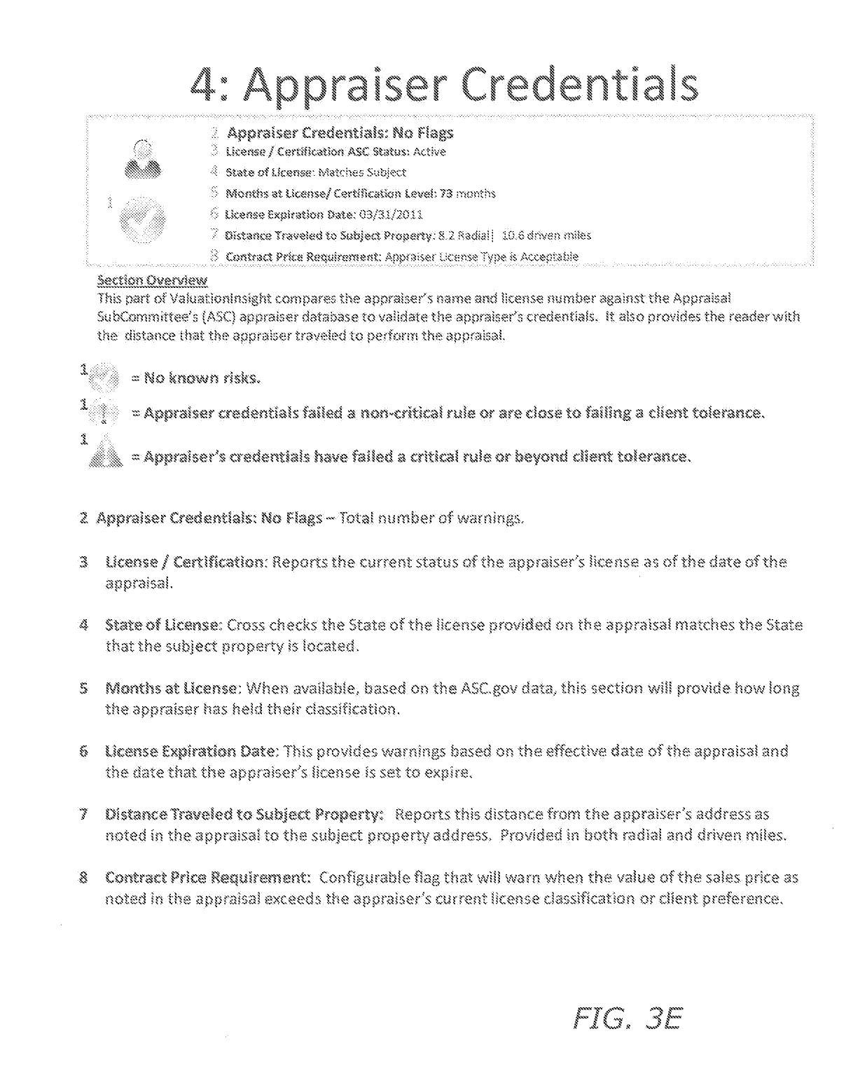

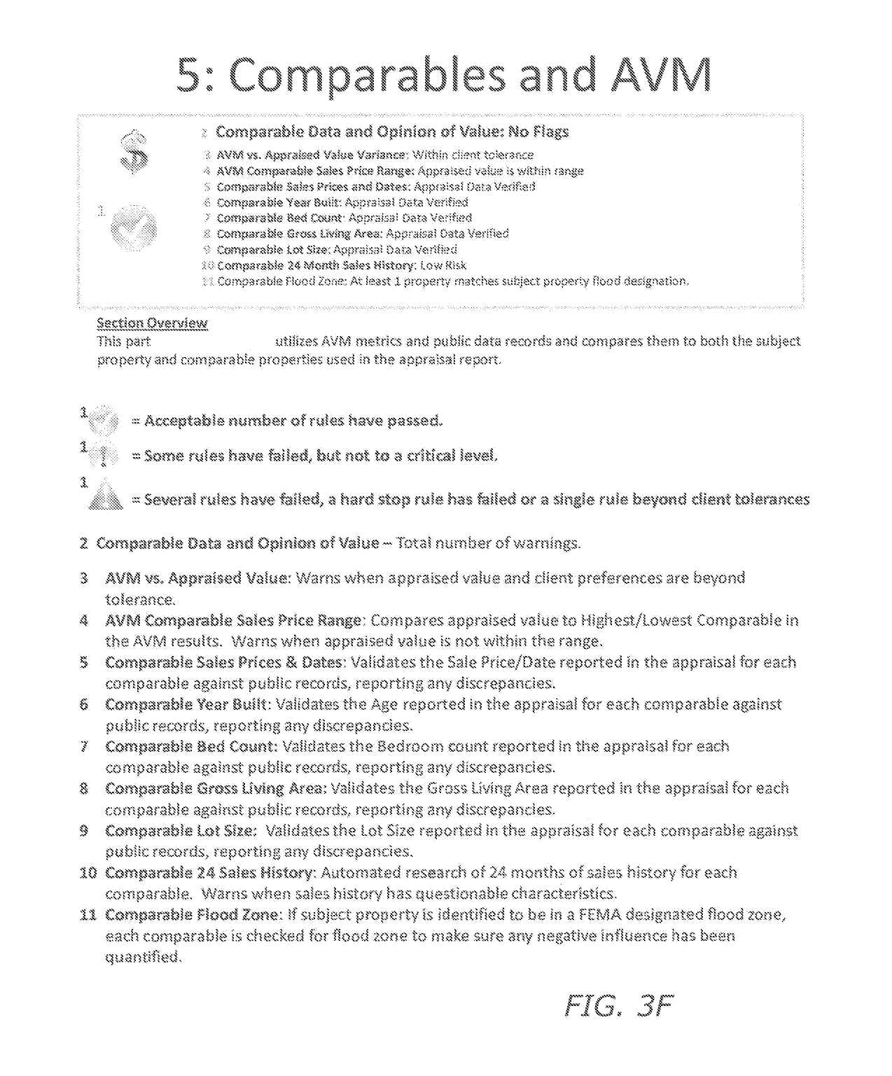

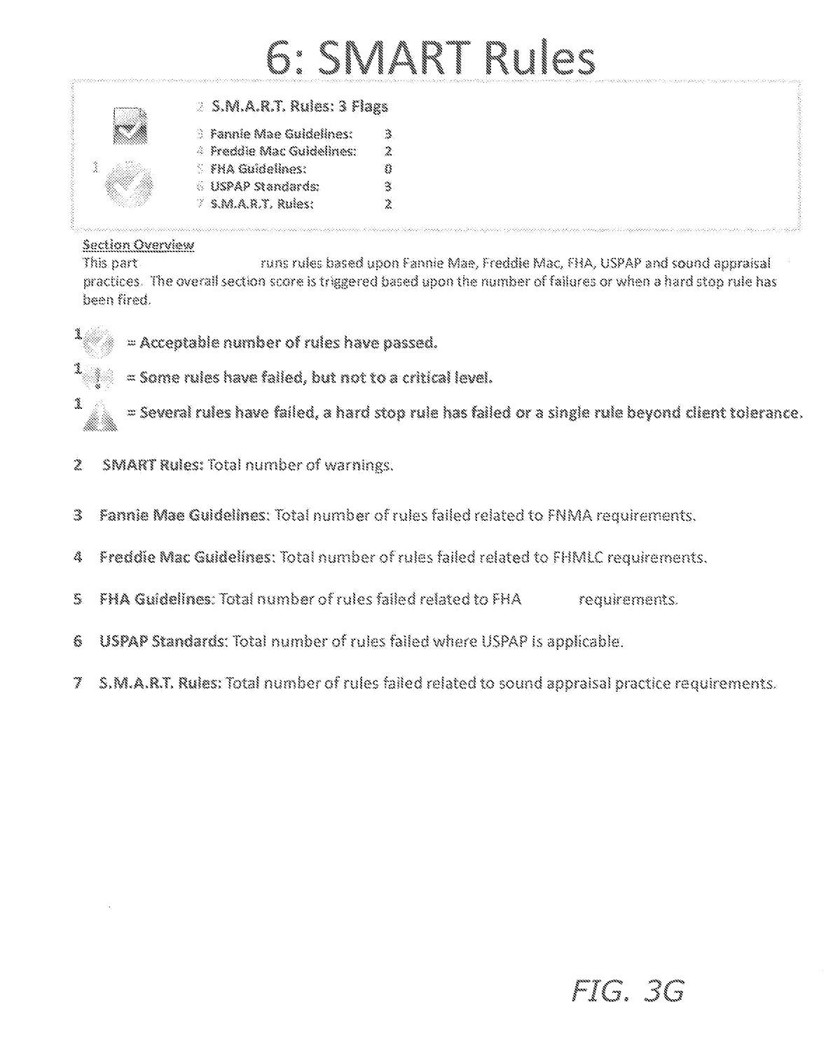

FIGS. 3A-3G illustrate pages of an exemplary sample report, each page (i.e., FIGS. 3A-3G) itself being an exemplary embodiment.

FIG. 3A is an example of a report cover page in accordance with an embodiment of the present invention. The present example shows a report with a low appraisal risk, indicated by a green flag. The generated report 155 displays information related to the target property and client. In a glance, a lender is able to see the specific matter information 1, appraisal risk 2, subject property complexity 3, appraiser credentials 4, comparable data 5, and violation of any threshold rules 6. The specific matter information 1 in the header may include the date, file number, client, client reference number, appraisal reference number, appraisal effective date, property address, city/state/zip, borrower, and appraisal value. In this non-limiting example, the appraisal risk 2 is indicated by a colored flag and a numerical score. Under the general scoring methodology, all appraisals start off with a score of 1,000 points and points are subtracted from this total each time a rule is triggered. Results from the rule processing are combined and deducted from 1,000 points with the final result reported as an overall score. Using this score, a recommendation of appraisal risk is determined as low, medium, or high. A short summary below the recommendation elaborates on how that recommendation was reached. Based on that appraisal risk, an action is recommended, such as “low level underwriting,” as in the exemplary embodiment shown.

In this example, the subject property complexity 3 is indicated by a house icon and a colored indicator. The colored indicator may be other shapes or colors, such as green, yellow, red, or blue, depending on the results of the subject market complexity analysis. Accordingly, in the exemplary embodiment shown, the subject market complexity was analyzed by taking into account the flood zone status, population density, REO market, property conformity, and market data availability. Such information may be extracted from external databases. After comparing these data points, the subject property was determined to be non-complex, as explained in the short paragraph following the initial indication. As such, no flags were raised. In this non-limiting example, the appraiser credentials 4 are indicated by an appraiser icon and a colored indicator. The colored indicator may be other shapes or colors, such as green, yellow, red, or blue, depending on the results of the appraiser credentials analysis. In the embodiment shown, the appraiser's credentials were analyzed by taking into account their license/certification status, state of license, months at license/certification level, license expiration date, distance traveled to subject property, and contract price requirement. After comparing these data points, the appraiser's credentials were deemed satisfactory, and did not raise any flags.

Moreover, in the example provided, comparable data 5 is indicated by a comparable data icon and a colored indicator. The colored indicator may be other shapes or colors, such as green, yellow, red, or blue, depending on the results of the comparable data analysis. In the embodiment shown, the comparable data was analyzed by taking into account factors including, but not limited to, comparable sales price range, sale prices and dates, year built, bed count, gross living area, lot size, sales history and flood zone. After comparing these data points, the subject property did not raise any flags. Finally, the threshold rules 6 are indicated by a rules symbol and a colored indicator. The colored indicator may be other shapes or colors, such as green, yellow, red, or blue, depending on the results of the threshold rules. In the embodiment shown, the threshold rules were analyzed by taking into account guidelines from Fannie Mae, Freddie Mac, the FHA and USPAP standards, and other rules from external databases. After comparing these data points, the subject property raised three flags.

FIG. 3B is an example of a report header in accordance with an embodiment of the present invention. FIG. 3B further specifies the meaning of each element in the report header, such as the 1) date, 2) file number, 3) client, 4) client reference number, 5) appraisal reference number, 6) appraisal effective date, 7) property address, 8) city/state/zip, 9) borrower, and 10) appraisal value. Such information provides the lender a quick reference for necessary information for each matter.

FIG. 3C is an example of an overall report score in accordance with an embodiment of the present invention. FIG. 3C further specifies the meaning of each element in the overall report score, such as 1) the visual indicators for overall risk, 2) appraisal score, 3) overall report score, 4) summary of each scored section, and 5) recommended action. In this non-limiting example, the visual indicators for overall risk are based on appraisal scoring ranges. In the embodiment shown, the range for the Low Risk Appraisal is 900-1000, the range for the Moderate Risk Appraisal is 689-899, and the range for High Risk Appraisal is less than 689. It should be appreciated that this is only one example. Depending on various factors, the ranges could be different. For instance, in another embodiment the range for the Low Risk Appraisal is 800-1000, the range for the Moderate Risk Appraisal is 600-799, and the range for High Risk Appraisal is less than 600. The summary of each scored section provides the lender with a short paragraph on how the appraisal risk was determined. Based on the appraisal risk score, an action, customizable by each client, is accordingly recommended.

FIG. 3D is an example of a subject property complexity in accordance with an embodiment of the present invention. FIG. 3D further specifies the meaning of each element in the subject property complexity section, such as 1) the visual indicator, 2) subject property complexity, 3) flood zone status, 4) population density, 5) REO market report, 6) property conformity, 7) market data availability, and 8) non-disclosure state flag. This section of the report runs the subject property address through numerous data resources. The responses provide the reader of the appraisal report additional market data points that are beyond what is typically found in an appraisal. The results will either indicate that the subject property's characteristics are typical, complex, or very complex in terms of the degree of difficulty in meeting traditional appraisal guidelines. A green check mark may indicate that the results are typical (property and market conditions are not complex). An exclamation mark in a yellow circle may indicate that the results are complex (some property and/or market conditions are complex). An exclamation mark in a red triangle may indicate that the results are very complex (several property and/or market conditions are complex). The subject property complexity, as indicated by flags, displays the total number of warnings. The flood zone data provides either a yes or no response regarding FEMA flood zone status based on flood data services. If yes, additional rules are triggered regarding the flood zone status of comparables used in the appraisal. Population density reports the level of density in terms of low, average, or high. The lower the density, the more difficult comparable selection can become. REO market reports the level of REO activity in the subject's market, allowing the reader of the appraisal to understand the use or non-use of REO comparable sales. Property conformity is based on the subject property's physical characteristics. This provides the level of conformity of the improvements compared to the market surrounding the subject property. Market data availability reports the level of complexity based upon the number of sales over the past 12 months and the ratio of those sales which are comparable to the subject. Non-disclosure state status flags the reader that the subject property is or is not located in a non-disclosure state, which may make it difficult for the appraiser to provide certain information about the comparable sales.

FIG. 3E is an example of an appraiser's credentials in accordance with an embodiment of the present invention. FIG. 3E further specifies the meaning of each element in the appraiser's credentials section, such as 1) the visual indicator, 2) appraiser's credentials flags, 3) license/certification, 4) state of license, 5) months at license, 6) license expiration date, 7) distance traveled to subject property, and 8) contract price requirement. This section of the report compares the appraiser's name and license number against the Appraisal Subcommittee's (ASC) appraiser database to validate the appraiser's credentials. It also provides the reader with the distance that the appraiser traveled to perform the appraisal. Again, indicators are used to quickly show the status of a section. A green check mark indicates that there are no known risks. An exclamation mark in a yellow circle may indicate that the appraiser credentials failed a non-critical rule or are close to failing a client tolerance. An exclamation mark in a red triangle may indicate that the appraiser's credentials have failed a critical rule or are beyond client tolerance. The appraiser credentials, as indicated by flags, displays the total number of warnings. License/certification reports the current status of the appraiser's license as of the date of the appraisal. State of license cross-checks the state of the license provided on the appraisal matches the state that the subject property is located. When available, based on the ASC.gov data, the months at license section will provide how long the appraiser has held their classification. License expiration date provides warnings based on the effective date of the appraisal and the date that the appraiser's license is set to expire. Distance traveled to subject property reports the distance, in both radial and driven miles, from the appraiser's address as noted in the appraisal to the subject property address. Contract price requirement is a configurable flag that will warn when the value of the sales price as noted in the appraisal exceeds the appraiser's current license classification or client preference.

FIG. 3F is an example of comparables in accordance with an embodiment of the present invention. FIG. 3F further specifies the meaning of each element in the comparables section, such as 1) the visual indicator, 2) comparable data flags, 3) appraised value tolerance, 4) comparable sales range, 5) comparable sales prices and dates, 6) comparable year built, 7) comparable bed count, 8) comparable gross living area, 9) comparable lot size, 10) comparable 24 months sales history, and 11) comparable flood zone. This section of the report utilizes Automated Valuation Model (AVM) metrics and public data records and compares them to both the subject property and comparable properties used in the appraisal report. A green check mark may indicate that an acceptable number of rules have passed. An exclamation mark in a yellow circle may indicate that some rules have failed, but not to a critical level. An exclamation mark in a red triangle may indicate that several rules have failed, a hard stop rule has failed, or a single rule beyond client tolerances. The comparable data and opinion of value, as indicated by flags, displays the total number of warnings. AVM vs. appraised value warns the reader when appraised value and client preferences are beyond tolerance. AVM comparable sales price range compares appraised value to the highest and lowest comparables in the AVM results and warns the reader when the appraised value is not within the range. Comparable Sales Prices and Dates validates the Sale Price/Date reported in the appraisal for each comparable against public records, reporting any discrepancies. Comparable Year Built validates the age reported in the appraisal for each comparable against public records, reporting any discrepancies. Comparable Bed Count validates the bedroom count reported in the appraisal for each comparable against public records, reporting any discrepancies. Comparable Gross Living Area validates the gross living area reported in the appraisal for each comparable against public records, reporting any discrepancies. Comparable Lot Size validates the lot size reported in the appraisal for each comparable against public records, reporting any discrepancies. Comparable Sales History is an automated search of 24 months of sales history for each comparable, which warns when sales history has questionable characteristics. Comparable Flood Zone applies if a subject property is identified to be in a FEMA designated flood zone, each comparable is checked for flood zone to make sure any negative influence has been quantified.

FIG. 3G is an example of threshold rules in accordance with an embodiment of the present invention. FIG. 3G further specifies the meaning of each element in the threshold rules section, such as 1) the visual indicator, 2) rules warnings, 3) Fannie Mae guidelines, 4) Freddie Mac guidelines, 5) FHA guidelines, 6) USPAP standards, and 7) SMART rules. This section of the report checks rules based upon Fannie Mae, Freddie Mac, FHA, USPAP and sound appraisal practices. The overall section score is triggered based upon the number of failures or when a hard stop rule has been fired. A green check mark may indicate that an acceptable number of rules have passed. An exclamation mark in a yellow circle may indicate that some rules have failed, but not to a critical level. An exclamation mark in a red triangle may indicate that several rules have failed, a hard stop rule has failed, or a single rule is beyond client tolerance. The rules, as indicated by flags, display the total number of warnings. Fannie Mae Guidelines displays the total number of rules failed related to Fannie Mae requirements. Freddie Mac Guidelines displays the total number of rules failed related to Freddie Mac requirements. FHA Guidelines displays the total number of rules failed related to FHA requirements. USPAP Standards displays the total number of rules failed where USPAP is applicable. Statistical Market Analysis Real Time (S.M.A.R.T.) rules display the total number of rules related to sound appraisal practice requirements. These rules may incorporate numerous standards and guidelines, including, for example, standards and guidelines of governmental agencies.

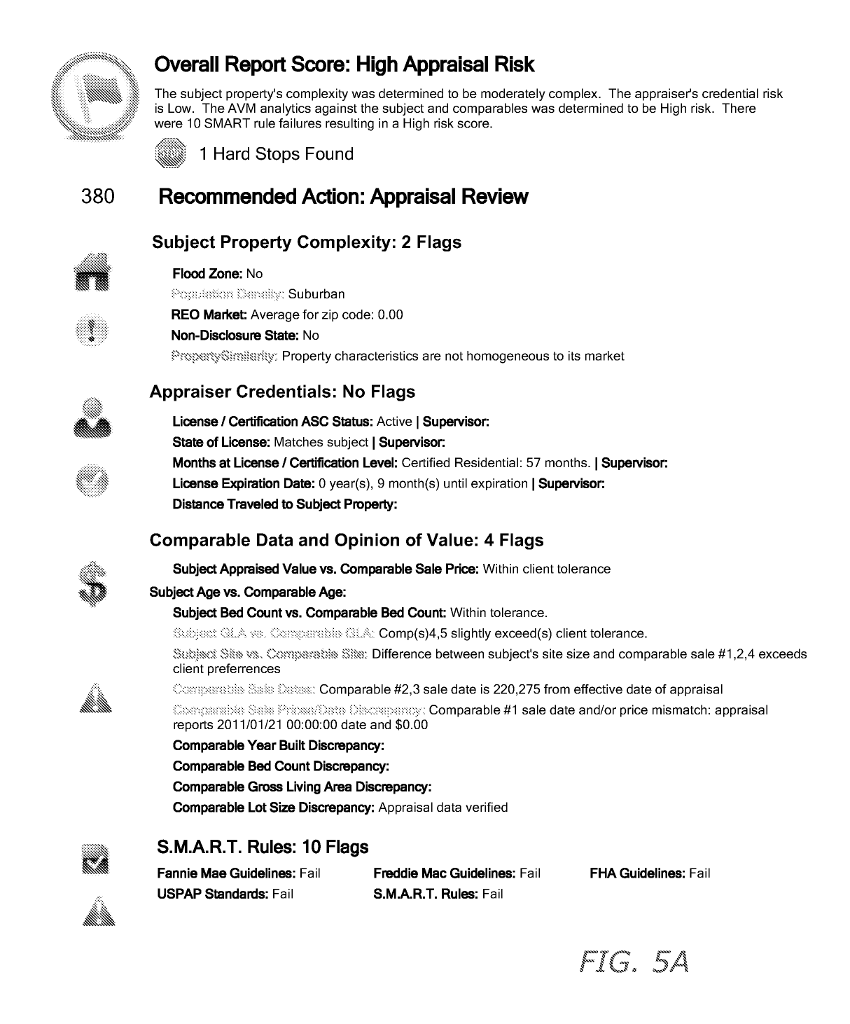

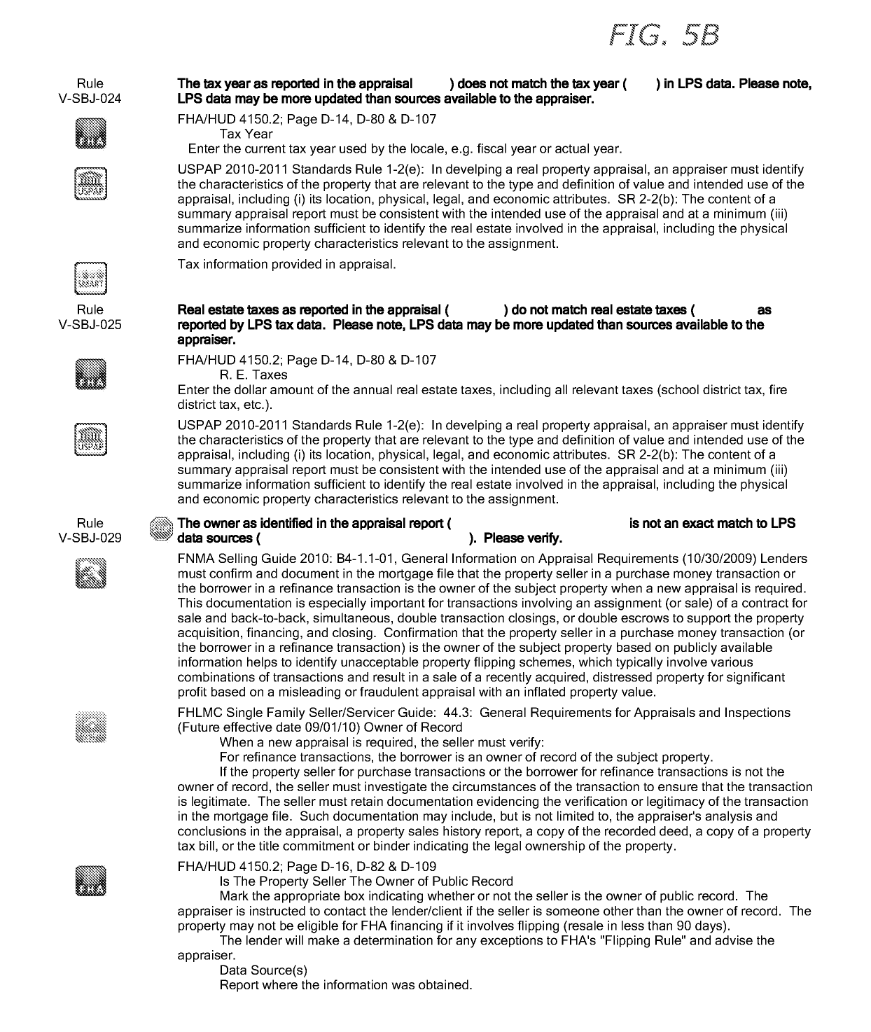

FIG. 5A is an example of a high appraisal risk report cover page. The high appraisal risk is immediately identified by a red flag, a low appraisal report score, and a hard stop sign. The areas needing correction are highlighted, while the areas that are in accordance with the rules are indicated by a green check mark. In this non-limiting example, the property characteristics are not homogenous to the market, the difference between the subject property's site size and comparable sales exceeds client preferences, and all the rules failed. Accordingly, in the exemplary embodiment shown, the report score was a low and resulted in a high appraisal risk, requiring appraisal review.

FIG. 5B is an example of a rules violation report page. The page lists the specific relevant rule and current violation, as well as procedures to correct the violations. If a hard stop is found, that is noted with a red stop sign. In this non-limiting example, the tax year and real estate taxes do not match outside data. Accordingly, in the exemplary embodiment shown, the procedures to correct are noted, along with any hard stops.

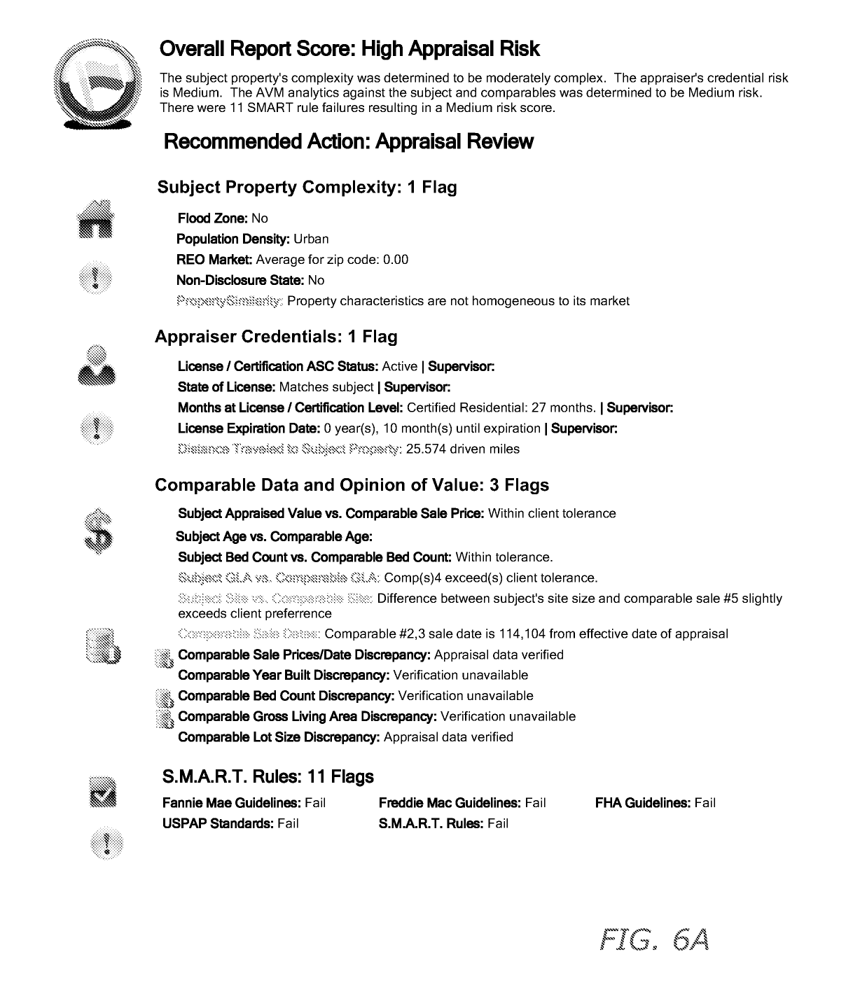

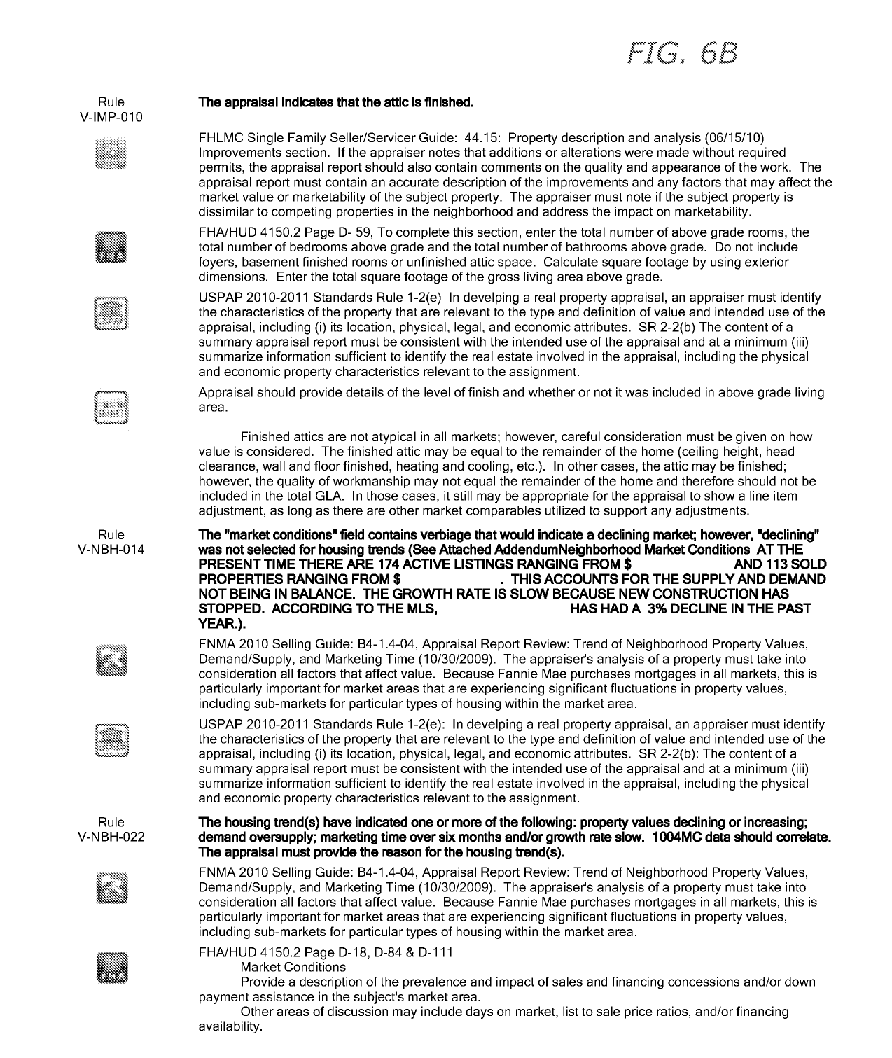

FIG. 6A is an example of a blue high appraisal risk report cover page. The color Blue indicates that outside data providers were unable to complete data verification, so an appraisal review is recommended. For example, in comparable data 5, the last three areas of data could not be verified and are noted as such. In this example, the property characteristics are not homogenous to the market, the difference between the subject property's site size and comparable sales exceeds client preferences, and all the rules failed. Accordingly, the report score was a low and resulted in a high appraisal risk, requiring appraisal review.

FIG. 6B is another example of a rules violation report. This report shows the relevant rules and data that could not be verified by outside data providers. In this example, the appraisal indicates that the attic is finished, resulting in a blue flag. Accordingly, the report required additional data.

The validation report, according to embodiments described herein, supports customization to meet specific client needs. Rules can be turned on or off as part of client configuration. Rules include customizable thresholds and tolerances to match client's underwriting and risk management policies. Clients may have options, outlined in Table 1, for configuration of rules and related features. It should be noted that Table 1 is for illustrative purposes only and is not intended to limit the field names, default tolerances, etc. of the embodiments described herein.

As seen in Table 1, the system may have default configurations relating to the subject property complexity, appraiser credentials, comparable data, and rules. For example, one factor in determining the subject property's complexity is the REO market. REO stands for Real Estate Owned and refers to properties that were foreclosed upon but failed to sell at auction. By default, the REO market field is on (used to calculate complexity), and set with parameters of 1%-10% in the low range, greater than 10% to less than 20% in the medium range, and greater than 20% in the high range. However, a client may define the parameter ranges differently or not use the REO market as a factor in the appraisal report. By default, the subject property complexity is determined by analyzing the flood zone, population density, REO market, whether the property is in a non-disclosure state, and property similarity. Appraisal credentials are verified by determining the appraiser's license status, state of license, months at license/certification level, license expiration date, and distance the appraiser traveled to the subject property. The comparable data is analyzed by looking at data from comparable homes in the area, such as age, bed count, sale dates, and discrepancies, among other data points. The rules in the system may consist of guidelines from Fannie Mae, Freddie Mac, the FHA, and USPAP standards. Any of these parameters may be turned off or edited by the client to suit their preferences.

TABLE 1
Validation Report Configurations

| | | | |
|---|---|---|---|
| Field Name | Field On or Off | Default Tolerances | Client Defined Tolerances |

Subject Property Complexity

| | | |
|---|---|---|
| Flood Zone | On (default) | Low Range: 1-∞ comparables are in a flood zone |
| | | Med Range: N/A |
| | | High Range: 0-0 comparables are in a flood zone |
| Population Density | On (default) | Low Range Keywords: urban, inner city, city |
| | | neighborhood |
| | | Medium Range Keywords: suburban |
| | | High Range Keywords: small town, rural |
| REO Market | On (default) | Low Range: 0%-10% |
| | | Med Range: >10% and <20% |
| | | High Range: >20% |
| Non-Disclosure State | On (default) | Keywords: Alaska, AK, Idaho, ID, Indiana, IN, Kansas, |
| | | KS, Louisiana, LA, Maine, ME, Mississippi, MS, Missouri, |
| | | MO, Montana, MT, New Mexico, NM, North Dakota, ND, |
| | | Texas, TX, Utah, UT, Wyoming, WY |
| Property Similarity | On (default) | Low Range: 85%-100% |
| | | Med Range: 70%-<85% |
| | | High Range: 0%-<70% |

Appraiser Credentials

| | | |
|---|---|---|
| License/Certification ASC Status | On (default) | |
| State of License | On (default) | |
| Months at License/Certification Level | On (default) | Low Range: 12-∞ |
| | | Med Range: 6-<12 |
| | | High Range: 0-<6 |
| | | Keywords: AR, GA, HI, KY, MA, MI, MN, MO, MS, NC, NH, |
| | | NJ, OK, PA, UT, VA, WA, WI, WV, WY |
| License Expiration Date | On (default) | |
| Distance Travelled to Subject Property | On (default) | If Urban/Suburban: |
| (Driven) | | Low Range: 0-<7.5 |
| | | Med Range: 7.5-<15 |
| | | High Range: 15-∞ |
| | | If Rural: |
| | | Low Range: 0-<15 |
| | | Med Range: 15-<30 |
| | | High Range: 30-∞ |

Comparable Data and Opinion of Value

| | | |
|---|---|---|
| AVM vs. Appraised Value Variance | On (default) | Low Range: 0-10 |
| | | Med Range: >10-<20 |
| | | High Range: 20-∞ |
| AVM Comparable Sales Price Range | On (default) | |
| Subject Appraised Value vs. | On (default) | Low Range: 0-<20 |
| Comparable Sale Price | | Med Range: 20-<25 |
| | | High Range: 25-∞ |
| Subject Age vs. Comparable Age | On (default) | Low Range: 0-<5 |
| | | Med Range: 5-<9 |
| | | High Range: 9-∞ |
| Subject Bed Count vs. Comparable Bed | On (default) | Low Range: 0-<2 |
| Count | | Med Range: 2-<3 |
| | | High Range: 3-∞ |
| Subject GLA vs. Comparable GLA | On (default) | Low Range: 0-<12 |
| | | Med Range: 12-<20 |
| | | High Range: 20-∞ |
| Subject Site vs. Comparable Site | On (default) | Low Range: 0-<98 |
| | | Med Range: 98-<175 |
| | | while NO comp 175-∞ |
| | | High Range: 175-∞ |
| Comparable Sale Dates | On (default) | Low Range: 0-<90 |
| | | Med Range: 90-365 |
| | | High Range: >365-∞ |
| Comparable Sale Prices and Dates | On (default) | Low Range: 0-0 comparables |
| Discrepancy | | Med Range: 1-1 comparables |
| | | High Range: 2-∞ comparables |
| Comparable Year Built Discrepancy | On (default) | Low Range: All comps 0-<3 yr difference |
| | | Med Range: Any comp 3-<5 yr difference |
| | | while No comps >=5-∞ yr difference |
| | | High Range: Any comp >=5-∞ yr difference |
| Comparable Bed Count Discrepancy | On (default) | Low Range: All comps 0-<1 bed difference |
| | | Med Range: Any comp >=1-<2 bed difference |
| | | while No comp >=2-∞ bed difference |
| | | High Range: Any comp >=2-∞ bed difference |
| Comparable Gross Living Area | On (default) | Low Range: All comps 0-<5% difference |
| Discrepancy | | Med Range: Any comp >=5%-<10% difference |
| | | while No comp >=10%-∞ % difference |
| | | High Range: Any comp >=10%-∞ % difference |
| Comparable Lot Size Discrepancy | On (default) | Low Range: All comps 0-<5% difference |
| | | Med Range: Any comp >=5%-<10% difference |
| | | while No comp >=10%-∞ % difference |
| | | High Range: Any comp >=10%-∞ % difference |

S.M.A.R.T. ™ Rules

| Fannie Mae Guidelines | On (default) |
|---|---|
| Freddie Mac Guidelines | |
| FHA Guidelines | |
| USPAP Standards | |

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A method for determining the accuracy of an appraisal report using a computer-implemented application, comprising:
pre-validating an appraisal report to determine whether a first set of rules has been satisfied, the appraisal report including N fields to be completed, the first set of rules comprising completion of a pre-determined number of N fields;
proceeding to a post-validating step if the first set of rules is satisfied;
post-validating an appraisal report to determine whether a second set of rules has been satisfied, to provide an evaluation thereof, the evaluation including a plurality of risk categories including risk level indicators, and a risk-based overall score.

2. The method according to claim 1, wherein the pre-determined number of fields equals N or N−1.

3. The method according to claim 1, wherein the first set of rules further comprises comparing the date of the appraisal with the date on which the appraisal report is received.

4. The method according to claim 1, wherein the first set of rules further comprises ensuring that fields assigned for numerical entry only do not contain one or more alphabetic entries.

5. The method according to claim 1, wherein the first set of rules further comprises ensuring that each of the N fields is formatted according to pre-assigned formatting rules.

6. The method according to claim 1, wherein the appraisal report is sent back to an originating source if the first set of rules are not satisfied.

7. The method according to claim 1, wherein the post-validating includes accessing governmental data sources and comparing the data from the data sources with the fields pertaining to respective risk categories.

8. The method according to claim 1, wherein a second set of rules is automatically updated when updates are released by governmental data sources.

9. The method according to claim 1, wherein the risk categories are customizable such that unique thresholds may be established.

10. The method according to claim 1, wherein the post-validating includes analyzing property market characteristics of a property on which the appraisal report is based to determine a complexity value for the property.

11. The method according to claim 1, wherein the post-validating includes comparing a numerical appraisal value of the appraisal report with a computer generated appraisal value.

12. The method according to claim 1, wherein the evaluation results in a list of inconsistencies needing further review.

13. The method according to claim 1, wherein an appraiser's credentials are checked against an appropriate state licensing database to confirm the status and qualifications of the appraiser.

14. The method of claim 1, further comprising an algorithm, which weighs complexity of a property and test results to assign a score and risk factor to the appraisal report.

15. The method of claim 1, wherein the appraisal report contains a risk assessment level, a score regarding an analysis of the appraisal data, and a list of inconsistencies.

16. The method of claim 15, wherein the appraisal report is delivered in an electronic format.
